(19) United States
(12) Patent Application Publication
(10) Pub. No.: US 2012/0251021 A1
(43) Pub. Date: Oct. 4, 2012

(54) SELF-LUBRICATING STRUCTURE AND METHOD OF MANUFACTURING SAME

(76) Inventor: Gwo S. Swei, Vandalia, OH (US)

(21) Appl. No.: 13/079,591

(22) Filed: Apr. 4, 2011

(51) Int. Cl. F16C 33/10; B29C 39/00; B29C 39/12; B32B 27/00; B29C 71/00; B29C 71/04; C09J 5/02; B29C 39/02; B29C 70/00

(52) U.S. Cl. 384/13; 264/299; 264/308; 264/255; 264/337; 264/232; 264/131; 264/129; 264/483; 216/95; 156/324; 428/422

(57) ABSTRACT

A self-lubricating structure such as a bearing having a low coefficient of friction, a high bearing load capability, and a low abrasiveness is provided. The self-lubricating bearing has a PTFE-based sliding layer that is bonded to a metal backing layer. The sliding layer includes a PTFE-based matrix, self-lubricating fillers such as liquid crystalline polymer, and high temperature reinforcing fiber such as carbon fiber. A method for producing the self-lubricating bearing is also provided.

### CROSS-REFERENCES

This application is also related to co-pending application Ser. No. ______, entitled, “Self-Lubricating Structure and Method of Manufacturing the Same” filed on even date with the present application by the present applicant.

### BACKGROUND

Sliding surfaces are part of a number of practical applications. Bearings are an example of a sliding layers application. Some applications are referred to as self-lubricating as they require no external application of lubrication to parts that experience friction because the lubricant is self-contained. Bearings with a polymer-based self-lubricating sliding layer are used, for example, in applications where externally supplied lubricants are ineffective or difficult to implement.

A useful plastic sliding layer includes polytetrafluoroethylene (PTFE). PTFE has a low coefficient of friction, high chemical resistance, and maintains sliding characteristics at temperatures of up to 260° C. In some applications, a PTFE matrix is used in combination with fillers to form composite self-lubricating bearing materials having low friction and good mechanical properties. Fillers are added typically with the goal of improving bearing load capacity, strength and wear resistance. As used herein, the term “PTFE-based bearing” refers to bearings with a self-lubricating sliding layer having a PTFE-based matrix.

An example of a single layer PTFE-based bearing material is Rulon® J, a PTFE-based composite material manufactured by Saint-Gobain Performance Plastics that can be machined to make sleeve bearings.

Generally, PTFE has poor adhesion to metals. Accordingly, in conventional bearings, many different types of interlayers are applied to a metal backing first to hold the PTFE-based sliding layer which is then deposited onto the interlayer. In some applications, the interlayer serves as a reservoir for the PTFE and provides mechanical characteristics that improve the bearing's load capability and the bearing's thermal conductivity. Examples of such interlayers include a porous bronze layer sintered to the metal backing layer, a metal mesh bonded to the metallic backing layer, and a patterned structure embossed on the metal backing layer. In some applications, the interlayer provides adhesive characteristics and bonds the backing layer with the PTFE-based sliding layer. Examples of such interlayers include a hot melt bonding film layer, and an adhesive layer.

Multilayer PTFE-based bearings combine the characteristics of the metal backing layer, which provides dimensional and structural rigidity, compact design, and high load capability, with the self-lubricating properties of the PTFE-based sliding layer. Multilayer PTFE-based bearings are generally thinner than single layer PTFE-based bearings. They can be cut into blanks and used as flat bearing strips, or rolled and formed into simple cylindrical bushes, die-cut or deep drawn.

There are various methods of manufacturing conventional PTFE-based self-lubricating structures including sheets and bearings. One method for manufacturing a bearing includes sintering a porous bronze interlayer onto a metal backing layer, depositing a PTFE mush including lubricating fillers on the porous bronze interlayer, applying heat and pressure to the mush to impregnate it into the porous bronze interlayer and to consolidate it. A method for manufacturing a self-lubricating sheet includes preparing a PTFE billet filled with self-lubricating fillers and skiving the billet to produce a PTFE-based self-lubricating sheet. The sheet, a bonding film, and a metal backing can then be laminated under heat and pressure to make a multilayer self-lubricating bearing.

It remains desirable to have an improved PTFE-based self-lubricating structure exhibiting good operating characteristics such as low coefficient of friction and high load bearing capability which is more easily and cost-effectively manufactured.

### SUMMARY

Embodiments of the invention provide a bondable self-lubricating sheet that can be applied to a metal backing to make, for example, a bearing. The composition of the self-lubricating sheet includes a PTFE-based matrix and self-lubricating fillers. In an alternative embodiment, the bondable self-lubricating sheet includes high temperature fibers. In some embodiments, the self-lubricating sheet is deposited in one pass using a casting process and has a substantially uniform structure. In alternative embodiments, the self-lubricating sheet is deposited in more than one pass. In some of these alternative embodiments, the self-lubricating sheet has a varied structure. The bondable PTFE-based self-lubricating sheet enables a bearing having a low coefficient of friction, high bearing load capability, and low abrasiveness.

The present invention together with the above and other advantages may best be understood from the following detailed description of the embodiments of the invention illustrated in the drawings, wherein:

### DRAWINGS

FIG. 1 is a cross-sectional view of a self-lubricating bearing according to principles of the invention;

FIG. 2 is a flow chart of a process of manufacturing the self-lubricating bearing of FIG. 1; and

FIG. 3 illustrates a coating composition for use in manufacturing the self-lubricating bearing of FIG. 1.

### DESCRIPTION

Embodiments of the invention provide a bondable self-lubricating sheet that can be applied to a metal backing to make, for example, a bearing. The composition of the self-lubricating sheet includes a PTFE-based matrix and self-lubricating fillers. In an alternative embodiment, the bondable self-lubricating sheet includes high temperature fibers. In some embodiments, the self-lubricating sheet is deposited in one pass using a casting process and has a substantially uniform structure. In alternative embodiments, the self-lubricating sheet is deposited in more than one pass. In some of these alternative embodiments, the self-lubricating sheet has a varied structure. The bondable PTFE-based self-lubricating sheet enables a bearing having a low coefficient of friction, high bearing load capability, and low abrasiveness.

Embodiments of the invention also provide a method of depositing a PTFE-based coating onto a temporary base layer or substrate and peeling the coating away from the substrate in order to make a PTFE-based self-lubricating cast sheet. The method includes the steps of providing a high temperature substrate with good release characteristic, and preparing a waterborne coating composition. The waterborne coating composition has a PTFE dispersion, self-lubricating fillers, and optionally high temperature fibers. The method of depositing the PTFE-based coating further includes the steps of coating the composition directly on the substrate, evaporating the water, and sintering the coating above the PTFE melting temperature. The method produces a PTFE-based self-lubricating cast sheet having desirable characteristics through a process that is stream-lined and efficient. Further, methods disclosed herein can produce bondable PTFE-based self-lubricating cast sheet that can be bonded to a metal backing to make, for example, a bearing.

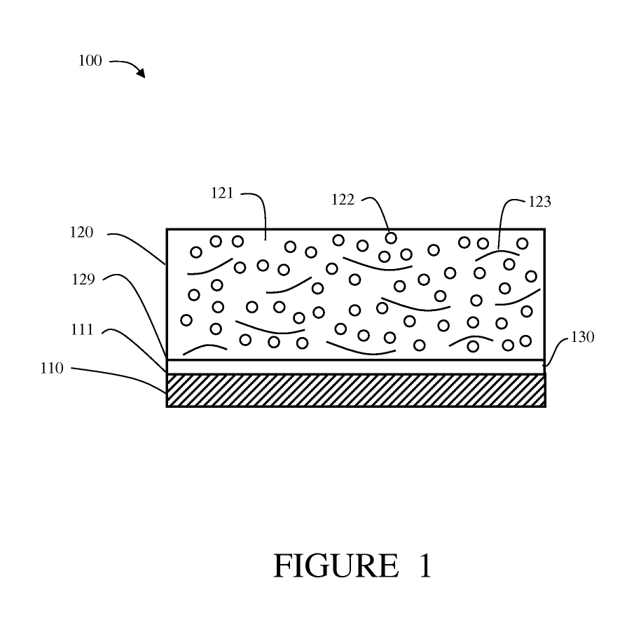

FIG. 1 shows an embodiment of a PTFE-based self-lubricating structure according to principles of the invention. It is, for example, a bearing. The PTFE-based self-lubricating structure 100 is shown in cross-section. It includes a backing 110, a PTFE-based self-lubricating cast sheet 120, and an adhesive interlayer 130. The backing layer 110 provides dimensional and structural rigidity. The backing layer 110 may be fabricated from various metals or metal alloys including steel, aluminum, stainless steel, copper alloys, and aluminum alloys. The PTFE-based self-lubricating cast sheet 120 forms a sliding layer. The cast sheet has a bondable surface 129, so it can be bonded to the receiving surface 111 of the metal backing using the adhesive interlayer 130. Throughout this disclosure, the term “sheet” refers to a flat material that has a thickness between approximately 10 micron and 3 mm.

In a first embodiment, the PTFE-based self-lubricating cast sheet 120 includes, by volume, 50-95% of PTFE-based matrix 121, 4.5-50% self-lubricating fillers 122. In a second alternative embodiment, the PTFE-based self-lubricating cast sheet 120 further includes 0.5-30% high temperature fibers 123. In a third alternative embodiment, the high temperature fibers include high temperature organic fibers. Throughout this disclosure, the term “self-lubricating” refers to a material that exhibits lubricity and limited abrasiveness. The term “high temperature fiber” refers to a fiber-like material that can withstand the PTFE processing and sintering temperature without significantly degrading its properties. The term “high temperature organic fiber” refers to a high temperature fiber that contains the element carbon. Throughout this disclosure, the word “sintering” refers to a process where small particles under the action of heat and/or pressure are fused together to form a solid material. The self-lubricating fillers 122 are typically homogeneously distributed throughout the PTFE-based matrix 121. The composite structure and the composition of the PTFE-based self-lubricating cast sheet enables a sliding layer with a low coefficient of friction, low wear, high load capability, and low abrasiveness. Low abrasiveness is desirable when the structure is used with a soft mating surface such as aluminum. The use of self-lubricating fillers 122 reduces the wear of the PTFE-based matrix 121 without significantly increasing the coefficient of friction and abrasiveness of the PTFE-based sliding layer. The use of the high temperature fibers 123 such as high temperature organic fibers increases the resistance to creep and compressive strength, thus improves the load capability without increasing the abrasiveness.

The PTFE-based matrix 121 is made up of 60-100% by weight PTFE. Throughout this disclosure, the term “PTFE” refers to a homopolymer of tetrafluoroethylene or a copolymer of tetrafluoroethylene with such small concentrations of copolymerizable modifying monomers where the melting point of the resultant polymer is not lower than 320° C.

In addition, the PTFE-based matrix can include 1-40 wt % high temperature melt processable polymers. Throughout this disclosure, the term “high temperature melt processable polymers” refers to a melt processable polymer that can withstand the PTFE processing and sintering temperature without significantly degrading its properties. Examples of high temperature melt processable polymers that may be used in embodiments of the invention include melt processable fluoropolymers such as fluorinated ethylene-propylene (FEP), perfluoroalkoxy polymer (PFA), monofluoroalkyl polymer (MFA), Tetrafluoroethylene-ethylene (ETFE), Polyvinylidene Fluoride (PVDF), and polychlorotrifluoroethylene (PCTFE). Other examples of high temperature melt processable polymers include polyphenylene sulfide (PPS), polyetheretherketone (PEEK), thermoplastic polyimide (TPI), polyetherimide (PEI), polyamide imide (PAI), and liquid crystal polymers (LCP). The use of a high temperature melt processable polymer increases the resistance to creep and load bearing capability without significantly increasing the coefficient of friction.

The self-lubricating fillers 122 can be inorganic or organic. Examples of inorganic self-lubricating fillers include calcium fluoride, magnesium fluoride, molybdenum disulfide, or other metal sulfide with a lamellar structure, boron nitride, lead oxide, lead alloys, and tin alloys. Examples of organic self-lubricating fillers include graphite, polyimide, polyphenylene sulfone, polyetheretherketone, polyamide imide, and aromatic polyester liquid crystal polymers. A wide range of size, shape and combination of self-lubricating fillers 122 are effective in embodiments of the present invention. The use of self-lubricating fillers 122 increases the wear resistance and the creep resistance without substantially increasing the coefficient of friction of the PTFE-based self-lubricating cast sheet 120. The use of organic self-lubricating fillers may be used when a PTFE-based sliding layer with a low abrasiveness is desirable. In one embodiment, the PTFE-based self-lubricating cast sheet120 is filled with p-oxybenzoyl homopolyester, an organic self-lubricating filler characterized by a low wear, a low coefficient of friction, and a low abrasiveness towards soft mating counterparts such as aluminum, brass, or plastic. P-oxybenzoyl homopolyester powders are available from Saint-Gobain under the trade name EKONOL®, from SUMITOMO CHEMICAL COMPANY, LIMITED under the trade name Sumikasuper® E101, and from Egene Optoelectronic Materials Company, Ltd. under the trade name SUPERNOL®. In one embodiment, the PTFE-based self-lubricating cast sheet is made up of between 5 and 45% per volume of p-oxybenzoyl homopolyester fillers with an average particle size between 2 and 20 microns.

High temperature fibers include inorganic fibers and high temperature organic fibers. Examples of inorganic fibers that are appropriate for embodiments of the present invention include acicular inorganic fillers such as wollastonite, chopped glass fibers, ceramic fibers, metallic fibers, submicron and nano-sized inorganic whiskers, and submicron and nano-sized inorganic fibers. Example of materials used to produce inorganic fibers or whiskers that are appropriate for embodiments of the present invention includes aluminum hydroxide, aluminum oxide, aluminum nitride, titanium dioxide, titanium nitride, silicon oxide, silicon nitride whiskers, zirconium oxide, zinc oxide, and iron oxide.

Examples of high temperature organic fibers that are appropriate for embodiments of the present invention include liquid crystal polymer fibers such as KEVLAR®, aramid fiber, pitch-based carbon fibers, cellulose-based carbon fibers, polyacrylonitrile-based carbon fibers, carbon nanofibers, and carbon natotubes. High temperature organic fibers have limited impact on the abrasiveness of the PTFE-based sliding layer. The addition of high temperature organic fibers increases the compressive strength and thus the load bearing capability of the PTFE-based sliding layer. In some embodiments, the combination of high temperature organic fibers such as graphite nano fiber and self-lubricating fillers such as p-oxybenzoyl homopolyester provides sliding layers with high bearing load capability, but surprisingly low coefficient of friction. The high temperature organic fibers may have an aspect ratio higher than 3, 10, 50, or even 250. In some embodiments, the high temperature organic fibers may have an average length less than the thickness of the PTFE-based sliding layer. In some embodiments, the high temperature organic fibers may have an average length larger than the thickness of the PTFE-based self-lubricating sheet. In some embodiments, the high temperature organic fibers are preferentially oriented in the directions parallel to the top surface of the self-lubricating cast sheet. In some embodiments, the compressive strength in the direction perpendicular to the surface of the sliding layer is multiplied by two or more due to the addition of high temperature organic fibers. Alternatively, the high temperature fiber may increase the thermal conductivity of the PTFE-based sliding layer. This enables a reduced operating temperature of the PTFE-based sliding layer, and thus results typically in an increase of the life of the application using the sliding layer.

Alternative embodiments of the PTFE-based self-lubricating cast sheet 120 also include 0-20% by volume extender fillers such as carbon black, graphite, graphene, talk, mica, iron oxide, clays, silica, calcium carbonate, titanium dioxide, alumina, iron oxide, nano-fillers, and inorganic pigments.

In a first embodiment, the PTFE-based self-lubricating cast sheet with a bondable surface is bonded to the backing 110 to make a self-lubricating structure. Generally, the bondable surface is characterized by a higher surface energy than PTFE. Untreated PTFE has a very low surface energy of 18 mN/m and cannot be bonded without surface pretreatment. The bondable surface should have a surface energy higher than 25 mN/m, and preferably higher than 35 mN/m. The surface energy of a plastic surface can be measured with surface tension pens. In some embodiments, the use of an external adhesive enables the bondable surface to bond to the backing material. In this embodiment, the PTFE-based self-lubricating cast sheet is referred to as an adhesive-bondable PTFE-based self-lubricating cast sheet. The adhesive can be thermoplastic or thermoset. Examples of thermoplastic adhesive include thermoplastic polyurethane, polyolefins, and melt-processable fluoropolymers such as FEP, PFA, ETFE, PVDF or MFA. Examples of thermoset adhesive include epoxy, silicone, polyimide, acrylic, polyurethane, and phenolic.

In alternative embodiments, the PTFE-based self-lubricating cast sheet has a multilayer structure with an outer layer having a melt-processable fluoropolymer such as FEP or PFA that can act as a holt-melt adhesive. In these embodiments, the PTFE-based self-lubricating cast sheet is referred to as self-bondable PTFE-based self-lubricating cast sheet. It can be directly bonded to a backing under heat and pressure when the lamination temperature is higher than the melt temperature of the melt-processable fluoropolymer. Methods to produce PTFE-based self-lubricating cast sheet with an adhesive bondable or a self-bondable surface are described below.

With regard to the backing material 110, a metal or a metal alloy such as stainless steel, aluminum, bronze, or brass may be used. A composite material with enough strength and rigidity such as glass reinforced composite may also be used as a backing. The backing material is preferably thin, has high heat conductivity to dissipate heat. The backing layer provides the bearing with dimensional and structural rigidity. In many applications, the bearings are cut, bent, or flanged. Accordingly, the backing material preferably has high yield strength (more than 50 MPA and preferably more than 150 MPA) and high modulus (more than 50 Gpa preferably 100 Gpa). The backing layer has a receiving surface 111 with a surface roughness Rz≧0.5 μm. In some embodiments, the receiving surface 111 is mechanically or chemically treated to achieve a surface roughness Rz higher than 1 micron and preferably higher than 2 microns. Examples of mechanical or chemical treatments usable to increase surface roughness in embodiments of the bearing include mechanical sandblasting, machining, brushing, acid or/and alkali etching, electro-chemical etching, zinc phosphate or zinc calcium phosphate treatment, galvanizing, and anodizing (in case of aluminum backing).

In some embodiments, the PTFE-based self-lubricating cast sheet can be made of several layers with different compositions. In these embodiments, the PTFE-based self-lubricating cast sheet is deposited in more than one pass. In each pass, the coating has a different composition which results in a PTFE-based self-lubricating cast sheet having a varied structure.

While the article manufactured on the substrate is referred to above as a “sheet”, it should be understood that the article could also have the form of a tape or a strip.

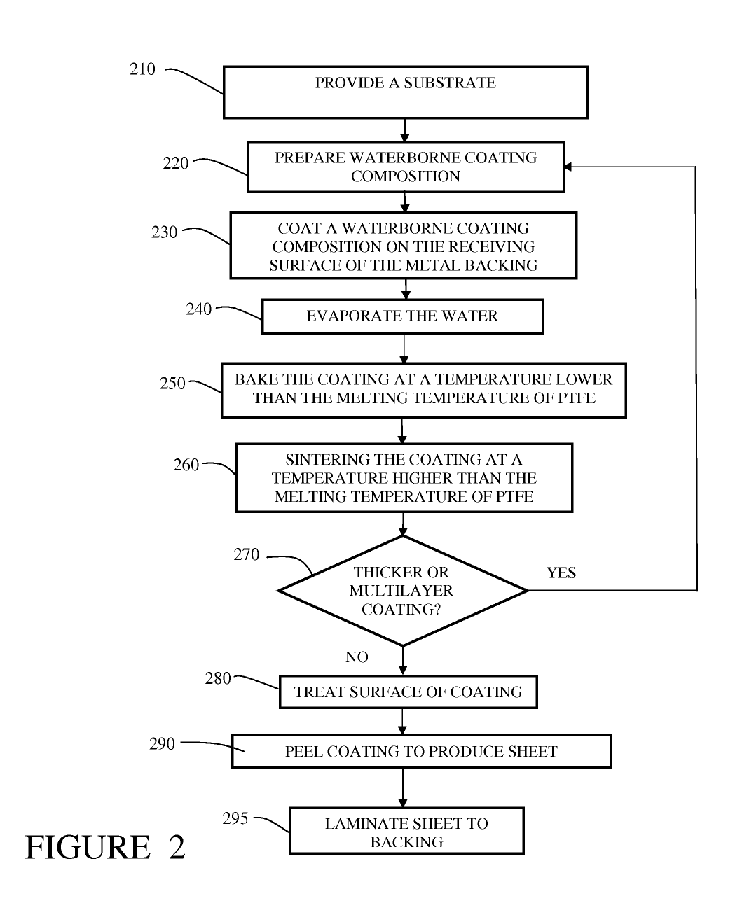

FIG. 2 shows a method of manufacturing a self-lubricating structure such as that shown in FIG. 1.

At step 210, a substrate is provided. The substrate has a smooth receiving surface. The substrate material is selected based on a number of characteristics. The substrate should have the capability of withstanding PTFE processing temperatures including the temperature of the sintering step. Further, the substrate material should have a good release characteristic, that is the receiving surface should be able to hold the coating during processing but then allow the processed layer to be stripped from the substrate Preferably the substrate should be reusable. In some embodiments, the substrate is made of a metal or metal alloy such as stainless steel. In alternative embodiments, the substrate is a film of high temperature polymers. Throughout this disclosure the term “high temperature polymer film” refers to a polymers film that does not melt or degrade at a temperature below 320° C. Examples of high temperature polymer films include polyimide films. These substrate materials are merely exemplary. One of skill in the art will understand that the present embodiment is not limited to the substrate materials listed here.

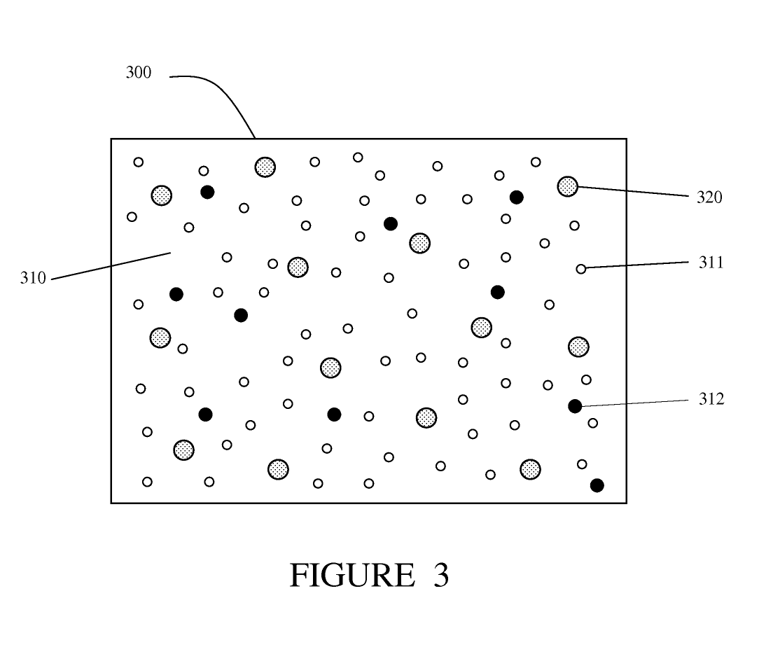

At step 220, a waterborne coating composition is prepared. This composition is described in greater detail below with regard to FIG. 3.

At step 230, the coating composition is coated directly on the receiving surface of the substrate. Examples of coating methods include spray coating, knife over roll coating, knife over plate coating, roll coating, curtain coating, slot die coating, dip coating, and gravure coating.

At step 240, the water in the coating composition is evaporated in an oven at a temperature generally between 50 and 150° C.

At step 250, the coated substrate is baked in an oven at a temperature lower than the melting temperature of the PTFE in order to remove volatiles.

At step 260, the coating layer is then sintered in an oven at a temperature higher than the melting temperature of the PTFE.

At step 270, the option of producing a thicker coating or a multilayer coating is presented. An advantage of the present method is that a coating can be deposited in multiple passes in order to make a thicker coating if the same PTFE-based composition is used or a multilayer coating if an alternative PTFE-based composition is used. Steps 220 through 260 are repeated to achieve the thicker or multilayer coating. Once the desired thickness or multilayer structure has been achieved, the processing advances to the next step. Generally, each pass deposits a coating layer of 50-150 micron. A deposit thicker than 150 micron is possible. In some embodiments, a deposit thinner than 50 microns is also possible.

At step 280, the surface of the coating is treated to make it bondable. Various methods are available for making the surface bondable. For example the surface can be chemically etched. This is done by etching processes well known in the industry that typically involve contacting the surface intended to be made bondable with an etching composition such as sodium metal/napthalene/glycol ether mixture, sodium metal/anhydrous ammonia mixture and the like. Another method includes depositing a thin fluoropolymer layer filled with high surface area inorganic particles such as silica. Other available methods include plasma treatment, metal sputtering, chemical vapor deposition, and physical vapor deposition techniques. The treatment is intended to make the surface of the coating adhesive-bondable. In one embodiment, the adhesive is applied in this step. In alternative embodiments, the adhesive is applied after step 290. In a further alternative embodiment, the coating is not treated to be adhesive-bondable but instead a melt processable fluoropolymer layer is deposited on the surface of the coating using steps 220 to 260 or using a process called extrusion coating. Such a layer is self-bondable and does not require the use of a further adhesive.

At step 290, the self-lubricating layer or multilayer is peeled off of the substrate to produce a sheet. This step and step 280 can be reversed in order. That is, the self-lubricating layer or multilayer can be peeled from the substrate first and then treated to make it bondable.

At step 295, the sheet is laminated to a backing using an adhesive to produce a multilayer self-lubricating structure such as a bearing. The adhesive can be thermoplastic or thermoset. Examples of thermoplastic adhesive include thermoplastic polyurethane, polyolefins, and melt-processable fluoropolymers such as FEP, PFA, ETFE, PVDF or MFA. Examples of thermoset adhesive include epoxy, silicone, polyimide, acrylic, polyurethane, and phenolic. The adhesive can be applied by direct or transfer coating onto the self-lubricating sheet, or the backing prior to lamination. If the sheet includes a self-bondable outer layer, the use of an additional adhesive is not required.

The methods exemplified by the above embodiment enable the manufacturing of PTFE-based self-lubricating cast sheets having structural characteristics and compositions that are generally difficult to achieve using other processes. The methods enable more degrees of freedom to achieve various compositions, and structures such as multilayer structures. Skiving, for example, conventionally does not produce a multilayer tape such as one that can be produced using the method described above. Further, the methods disclosed herein achieve a dense material with limited porosity without the use of high pressure. Further, in a PTFE-based composition having fibers, the skiving process cuts the fibers and does not enable tapes with fibers in a preferential direction.

FIG. 3 illustrates the waterborne coating composition 300. Throughout this disclosure, the term “waterborne coating composition” refers to a composition including water where the composition can be coated on a solid surface. The composition further includes a PTFE dispersion 311, a self-lubricating filler dispersion 320, and a liquid phase 310. The term “PTFE dispersion” refers to a dispersion of PTFE particles in a liquid. PTFE dispersions can be produced by emulsion polymerization using various methods known in the art and are available, for example, from E.I. Du Pont de Nemours and Company (DuPont) of Wilmington, Del., Asahi Company, Ltd. of Osaka, Japan, Daikin Industries, Ltd. of Osaka, Japan, and Dyneon L.L.C. of Oakdale, Minn., a subsidiary of 3M Company of Maplewood, Minn. Alternatively PTFE dispersions can be produced by dispersing fine PTFE powders in a liquid. In some embodiments, the PTFE dispersion includes PTFE particles less than 1 micron, for example, in the range of 100 to 500 nm. The term “self-lubricating filler dispersion” refers to self-lubricating fillers dispersed in a liquid.

The liquid phase 310 of the waterborne coating composition 300 includes a surfactant(s), and other additives. Surfactants are used to keep the PTFE particles and self-lubricating fillers in suspension in the liquid phase. Anionic fluorosurfactants or nonionic surfactants such as polyoxyalkylene alkyl are generally used to disperse the PTFE particles in water.

In some embodiments, the waterborne coating composition 300 includes a mixture of a PTFE dispersion 311 and one of several other polymer dispersions 312. Examples of other polymer dispersions include high temperature melt processable polymer dispersions. In one embodiment, the coating composition includes a combination of a PTFE dispersion and a FEP dispersion.

The dispersion having self-lubricating fillers can be prepared using various methods such as high shear mixing or ball milling. The choice of the surfactant to properly disperse the self-lubricating filler in water depends on the chemical nature of the self-lubricating filler. In one embodiment, the coating composition includes a dispersion of p-oxybenzoyl homopolyester fillers with an average particle size between 2 microns and 20 microns and a nonionic surfactant.

In another embodiment, the coating composition further includes a dispersion of fibers such as inorganic fibers or high temperature organic fibers. In conventional manufacturing processes that use mechanical methods, the fibers tend to be cut or otherwise damaged. The present method enables the physical integrity of the fibers to be maintained. In some embodiments, the method enables the fibers to orient preferentially in a plane parallel to the surface of the bearing. This preferential orientation resulting from the present method further increases the creep resistance of the bearing when a load is applied to the bearing in the direction perpendicular to the bearing surface.

The waterborne coating composition can further include various additives such as wetting agents to improve the coating quality, and anti-foaming agents to reduce air bubble and thus improve coating quality, pigments to add color, and a viscosity modifier. In one alternative embodiment, a waterborne coating composition includes a PTFE dispersion, a self-lubricating filler dispersion, a surfactant, and a viscosity modifier. The viscosity modifier in this embodiment is prepared and the level of viscosity modifier is adjusted to have a viscosity between 100 cps and 10,000 cps.

The waterborne coating composition 300 is suitable to be directly coated on the receiving surface of the substrate. The coating is dried to evaporate water, and then baked in an oven at a temperature sufficient to remove surfactants and other volatiles. The coating is finally sintered above the melting temperature of the PTFE particles. Contrary to other thermoplastic polymers, PTFE is not melt processable. Its melting temperature corresponds to a softening point. PTFE typically has a melt creep viscosity of at least one billion Pascal-second. In some embodiments the coating is sintered above 350° C.

In sum, a novel waterborne coating composition including a PTFE dispersion and self-lubricating fillers, used to produce a PTFE-based self-lubricating cast sheet is disclosed. The method disclosed herein includes sintering the PTFE particles together when the coating is baked at a temperature above the melting temperature of the PTFE to achieve a dense material with limited porosity without the use of high pressure.

The methods disclosed herein typically enable the production of PTFE-based self-lubricating cast sheet with a thickness between 25 and 250 microns. A thickness less than 25 microns is possible, but may reduce the bearing product life. A thickness higher than 250 microns is also possible, if longer bearing life is desired.

The methods disclosed herein were evaluated at the lab scale to apply the coating composition on a metal foil and on a plastic substrate. The processes for depositing the PTFE-based self-lubricating coating directly onto a substrate include spray coating, knife over roll coating, knife over plate coating, roll coating, slot die coating, dip coating, and gravure coating. The methods of the present invention are not limited to those processes listed here. One skilled in the art will understand that other coating processes are possible within the scope of the invention.

The bondable PTFE-based self-lubricating cast sheet fabricated in the methods described above may be used in a variety of multilayer self-lubricating bearing. For example a metal backing, a bonding film, a metal mesh, and the bondable PTFE-based self-lubricating cast sheet can be laminated together to produce a bearing with a high bearing load capability. A three dimensional honeycomb structure can also be embossed at the surface of a metal backing prior to the fabrication of the multilayer bearing using the bondable PTFE-based self-lubricating cast. In some embodiments, the PTFE-based self-lubricating cast sheet can be laminated to a backing including a porous bronze interlayer.

The self-lubricating bearings fabricated in the methods described above may be formed into a number of different structures including a variety of bearing types. These bearing types include bushes or journal bearings, thrust washers, and skid plates. For example, bushes or journal bearings may be formed by cutting the self-lubricating bearing into strips. Each of these strips may then be formed into hollow cylinders, with the PTFE-based sliding layer positioned on the inside cylindrical surface thereof, or alternatively, on the outside surface thereof, depending on the particular application. The cylindrical bearings may then be flanged using techniques familiar to those skilled in the art such as deep drawn. In some embodiments, the self-lubricating bearing may be laminated to a rubber-like backing prior and then be formed into any number of bearing type.

There now follow examples which illustrate the invention.

### Example 1

A waterborne dispersion of p-oxybenzoyl homopolyester particles with an average particle size of less than 10 microns available from Egene OptoElectronic Materials Company, Ltd. and a PTFE dispersion available from Dupont were mixed together to prepare a waterborne coating composition A. The relative weight ratios of p-oxybenzoyl homopolyester and PTFE in the coating composition were adjusted to provide a coating with 35 vol % p-oxybenzoyl homopolyester particles and 65 vol % PTFE.

The waterborne coating composition A was casted on a Kapton® polyimide film, available from Dupont, using an 8 path wet film applicator with a 508 microns gap. The coating composition was dried in an oven at 80° C. to evaporate water, and sintered in an oven at 360° C. to produce a PTFE-based self-lubricating coating. The PTFE-based self-lubricating coating was then peeled from the polyimide film to produce a cast PTFE-based self-lubricating cast sheet. The sheet had a thickness of 90 microns.

This demonstrates the capability of the method according to the present embodiment to produce a PTFE-based self-lubricating cast sheet.

### Example 2

A waterborne dispersion of colloidal silica particles, a FEP dispersion available from Daikin were mixed together to prepare a waterborne coating composition B. The relative weight ratios of colloidal silica and FEP in the coating composition were adjusted to provide a coating with 50 vol % colloidal silica particles and 50 vol % FEP.

The waterborne coating composition B was used to treat the surface of the PTFE-based self-lubricating coating of example 1. This was accomplished by applying a 10 micron thick layer of the waterborne composition B on the surface of the PTFE-based coating of example 1, drying in an oven at 100° C. to remove water, and sintering in an oven at 360° C. The PTFE-based self-lubricating coating treated with composition B was then peeled from the polyimide film to produce a bondable PTFE-based self-lubricating cast sheet.

The bondable PTFE-based self-lubricating sheet was then bonded with an epoxy based adhesive to a metal backing to produce a multilayer PTFE-based self-lubricating bearing.

The self-lubricating bearing of the present embodiment exhibited excellent adhesion ranked 5B according to ASTM D 3359-02.

### Example 3

A waterborne dispersion of p-oxybenzoyl homopolyester particles and nanosized carbon fibers with an aspect ratio of 400, and a PTFE dispersion were mixed together to prepare a waterborne coating composition C. The relative weight ratios of p-oxybenzoyl homopolyester, carbon fibers, and PTFE in the coating composition were adjusted to provide a coating with 27.5 vol % p-oxybenzoyl homopolyester particles, 5.5 vol % carbon fibers, and 67 vol % PTFE.

The waterborne coating composition C was casted on a polyimide film using an 8 path wet film applicator with a 508 microns gap. The coating was then dried in an oven at 80° C. to evaporate water, and then sintered in an oven at 360° C. to produce a PTFE-based self-lubricating coating with a thickness of 90 microns.

A FEP waterborne composition was then casted on the surface of the PTFE-based self-lubricating coating using, dried, and melted in an oven at 360° C. to produce a 10 micron thick self-bondable layer on the surface of the PTFE-based self-lubricating coating.

The PTFE-based self-lubricating coating coated with the FEP layer was finally peeled from the polyimide film to produce a self-bondable PTFE-based self-lubricating cast sheet.

### Example 4

The self-bondable PTFE-based self-lubricating cast sheet was directly bonded to a metal backing under heat and pressure to produce a multilayer PTFE-based self-lubricating bearing. The self-lubricating bearing of the present embodiment exhibited excellent adhesion ranked 5B according to ASTM D 3359-02.

### Example 5

The coefficient of friction of the PTFE-based self-lubricating cast sheets of examples 1 and 3 were measured using a universal testing machine equipped with a load cell and a coefficient of friction attachment based on ASTM D1894-01. The speed of the test was 175 mm/min, the surface of the sled was 40.3 cm², and the weight of the sled was 1250 g. The mating surface was a stainless steel foil with a surface roughness Rz of 0.8 micron. The coefficient of friction of a commercially available PTFE sheet was also measured for comparison.

| | | | Commercially |
|---|---|---|---|
| | Sheet | Sheet | available |
| | example 1 | example 3 | PTFE sheet |
| Kinetic coefficient of friction | 0.08 | 0.105 | 0.19 |

The compositions with p-oxybenzoyl homopolyester (example 1) and with p-oxybenzoyl homopolyester and carbon fibers (example 3) surprisingly have a kinetic coefficient of friction equal to or better than a sample of the PTFE sheet.

### Example 6

The PTFE-based self-lubricating bearing of example 2 and the self-lubricating bearing of example 4 were scratched using a plastic stylus under a pressure of 15 MPa. A deformation was exhibited in both bearing surfaces. The composition with p-oxybenzoyl homopolyester and carbon fibers (example 4) showed a smaller deformation (−3 times smaller) and thus a better creep resistance than the composition with no carbon fibers (example 2).

Embodiments of the self-lubricating structures described herein can be used in bearing applications as well as other applications where the use of a PTFE-based sheet with a low coefficient of friction and higher creep and wear resistance than pure PTFE is desirable. Examples of such applications include industrial protective coatings.

It is to be understood that the above-identified embodiments are simply illustrative of the principles of the invention. Various and other modifications and changes may be made by those skilled in the art which will embody the principles of the invention and fall within the spirit and scope thereof.

We claim:

1. A method of manufacturing a self-lubricating sheet, comprising:
providing a substrate having a receiving surface;
preparing a first waterborne coating composition comprising a PTFE dispersion and a self-lubricating filler dispersion;
coating the waterborne coating composition on the receiving surface;
evaporating the water from the coated receiving surface;
sintering the coating above the PTFE melting temperature to form a self-lubricating layer, wherein the self-lubricating layer comprises 50 to 95% by volume PTFE-based matrix and 5 to 50% by volume self-lubricating fillers, wherein the PTFE-based matrix comprises 60 to 100% by weight PTFE; and
removing the self-lubricating layer from the substrate to form the self-lubricating sheet.

2. The method of claim 1, further comprising repeating the steps of coating, evaporating and sintering to increase self-lubricating sheet thickness.

3. The method of claim 2 wherein the repeated coating step comprises using a second waterborne coating composition that differs from the first coating composition such that the self-lubricating sheet is multi-layered.

4. The method of claim 1 wherein the substrate is a metal foil.

5. The method of claim 1 wherein the substrate is a high temperature polymer film.

6. The method of claim 5 wherein the high temperature polymer film is a polyimide film.

7. The method of claim 1 further comprising treating the self-lubricating sheet to form a bondable surface.

8. The method of claim 7, wherein the treating step includes a process selected from the group consisting of chemical etching, plasma treatment, depositing a fluoropolymer layer filled with high surface area inorganic particles, metal sputtering, chemical vapor deposition, physical vapor deposition, or combination thereof.

9. The method of claim 7 wherein the treating step is performed before the step of removing the self-lubricating sheet from the substrate.

10. The method of claim 7 wherein the treating step is performed after the step of removing the self-lubricating sheet from the substrate.

11. The method of claim 7 further comprising adding a layer of adhesive material to the self-lubricating sheet.

12. The method of claim 11 wherein the adhesive material is a thermoset adhesive selected from the group consisting of epoxy, silicone, polyimide, acrylic, polyurethane, or phenolic.

13. The method of claim 11 wherein the adhesive material is a thermoplastic adhesive.

14. The method of claim 13 wherein the adhesive material is a selected from the group consisting of FEP, PFA, ETFE, PVDF, MFA, or combinations thereof.

15. The method of claim 1 further comprising depositing a melt processable fluoropolymer layer on the self-lubricating sheet by
coating a melt processable fluoropolymer composition layer on the sliding structure;
evaporating water from the melt processable fluoropolymer composition layer; and
melting the melt processable fluoropolymer composition layer.

16. The method of claim 1 further comprising depositing a melt processable fluoropolymer layer on the self-lubricating layer by extrusion coating.

17. The method of claim 1 further comprising the step of laminating the self-lubricating sheet to a backing.

18. The method of claim 17 wherein the backing is a metal backing.

19. A self-lubricating sheet formed by
providing a substrate having a receiving surface;
preparing a first waterborne coating composition comprising a PTFE dispersion and a self-lubricating filler dispersion;
coating the waterborne coating composition on the receiving surface;
evaporating the water from the coated receiving surface;
sintering the coating above the PTFE melting temperature to form a self-lubricating layer, wherein the self-lubricating layer comprises 50 to 95% by volume PTFE-based matrix and 5 to 50% by volume self-lubricating filler; wherein the PTFE-based matrix comprises 60 to 100% by weight PTFE; and
removing the self-lubricating layer from the substrate to form the self-lubricating sheet.

20. The self-lubricating sheet of claim 19, wherein the self-lubricating filler comprises organic self-lubricating filler.

21. The self-lubricating sheet of claim 20, wherein the organic self-lubricating filler is selected from the group consisting of graphite, polyimide, polyphenylene sulfone, aromatic polyester liquid crystal polymers, polyetheretherketone, and polyamide imide, or combinations thereof.

22. The self-lubricating sheet of claim 21, wherein the organic self-lubricating filler comprises p-oxybenzoyl homopolyester filler.

23. The self-lubricating sheet of claim 19 wherein the coating further comprises high temperature fibers.

24. The self-lubricating sheet of claim 23 wherein the high temperature fibers include high temperature organic fibers.

25. The self-lubricating sheet of claim 19 wherein the self-lubricating sheet has a substantially uniform structure.

26. The self-lubricating sheet of claim 19 wherein the self-lubricating sheet has a varied structure.

27. The self-lubricating sheet of claim 19 wherein the self-lubricating sheet has a bondable surface wherein the bondable surface as a surface energy higher than 25 mN/m.

28. A multilayer self-lubricating sheet formed by
providing a substrate having a receiving surface;
preparing a first waterborne coating composition comprising a PTFE dispersion and a self-lubricating filler dispersion;
coating the first waterborne coating composition on the receiving surface;
evaporating the water from the coated receiving surface;
sintering the first coating above the PTFE melting temperature to form a first layer of self-lubricating sheet;
preparing a second waterborne coating composition comprising a PTFE dispersion and a self-lubricating filler dispersion;
coating the second waterborne coating composition on the first layer;
evaporating the water from the second waterborne coating composition;
sintering the second coating above the PTFE melting temperature to form a second layer of self-lubricating sheet; and
removing the self-lubricating sheet from the substrate.

29. The multilayer self-lubricating sheet of claim 28 wherein the multilayer self-lubricating has a bondable surface wherein the bondable surface as a surface energy higher than 25 mN/m.

30. A bearing, comprising:
a backing layer; and
a sliding layer bonded to the backing layer, wherein the sliding layer was formed by providing a substrate having a receiving surface;
preparing a first waterborne coating composition comprising a PTFE dispersion and a self-lubricating filler dispersion;
coating the waterborne coating composition on the receiving surface;
evaporating the water from the coated receiving surface;
sintering the coating above the PTFE melting temperature to form a self-lubricating layer, wherein the self-lubricating layer comprises 50 to 95% by volume PTFE-based matrix and 5 to 50% by volume self-lubricating filler; wherein the PTFE-based matrix comprises 60 to 100% by weight PTFE; and
removing the self-lubricating layer from the substrate.
